(19) United States
(12) Patent Application Publication
(10) Pub. No.: US 2009/0034789 A1
(43) Pub. Date: Feb. 5, 2009

(54) MOVING THING RECOGNITION SYSTEM

(76) Inventors: Shun-Jen WANG, Keelung City (TW); Chun-Hsiang Lin, Taipei City (TW); Chih-Hsiang Lo, Taipei City (TW); Yuh-Xsing Sun, Jhongli City (TW)

Correspondence Address: SINORICA, LLC, 528 FALLSGROVE DRIVE, ROCKVILLE, MD, 20850, US

(21) Appl. No.: 11/831,210

(22) Filed: Jul. 31, 2007

(51) Int. Cl. G06K 9/00

(52) U.S. Cl. 382/103

(57) ABSTRACT

A moving thing recognition system using a camera on a path that the moving thing (such as a train, vehicle or ship) is proceeding, in which a check aligning device is used to align each picture file of the moving thing with virtual checks to compare for the body type and speed of the moving thing. The virtual checks of the moving thing are provided in taking the length of a fixed marking article or some other fixed article on the path of the moving thing as a reference. Thereby, under the circumstance that the path of the moving thing is unchanged and there is no emitted signal, accurate recognition can be obtained.

### BACKGROUND OF THE INVENTION

1. Field of the invention

The present invention relates to a moving thing recognition system, and especially to a recognition system judging the body type or speed of the moving thing by getting a picture file of pure pictures using a camera.

2. Description of the Prior Art

A recognition system for recognizing types, speeds and license plates of vehicles on a high way mostly is composed of a set of picture taking device and a radar speed detecting device. The picture taking device includes at least a camera and a flashlight; it can control activating of the picture taking device to get photo information of over speed vehicles.

In using of such a conventional recognition system, by the fact that the radar speed detecting device is to emit a light beam (such as that of laser or infrared beam etc.) to a vehicle, and then it can detect whether the vehicle is over speed. This results that, the vehicle can be mounted with a detector to notice the driver in advance to avoid being over speed; such a phenomenon renders the effect of preventing over speed with a recognition system to be largely reduced.

Sometimes, for taking picture, the picture taking device must use a flashlight, such a sudden flashing will shock a driver at times, and a traffic accident can be induced, in view of this, improvement of the conventional recognition system is wanted.

The technique of MJPEG (Motion JPEG—i.e. Motion Joint Photographic Experts Group) is a moving picture compressing technique derived from the technique of JPEG (Joint Photographic Experts Group); the MJPEG can generate serial moving pictures, it does not take consideration of changes among different pictures in the visual signal flow during the process of generating, but only does compression individually for each picture; such mode of compression much suit stationary pictures, it has an analyzing degree from 352×240 to 1280×1024. Thereby each of multiple serial picture files taken by a camera discloses clear and recognizable pictures. The present invention takes advantage of such a technique to improve recognition systems for vehicles.

### SUMMARY OF THE INVENTION

The main object of the present invention is to provide a moving thing recognition system using a camera being set to have a picture taking range on a path that the moving thing is proceeding, when the moving thing enters the picture taking range, a detecting device controls the camera in getting serial picture files; the data of longitudinal and latitudinal degrees and data of time of each picture file are obtained through a GPS (global positioning system) and a satellite, thus file names of these picture files can be all established. For each picture file, a check aligning device is used to align each picture file with virtual checks; these virtual checks are provided in taking the length of a fixed marking article or some other fixed article on the path of the moving thing as a reference. A body-type comparing device to judge the body type of the moving thing using the way of comparing pictures from a picture file of the full-length pictures taken by the camera. And a speed calculating device gets differences of distance and time by comparing at least two picture files taken by the camera to calculate the speed of the moving thing.

The present invention judges the body type and speed of the moving thing only with pictures; for instance, when it is applied to judge a train, a vehicle running on a high way and a ship on voyage, it needs only to put the camera at an appropriate position on the path, this does not change the environment and peripheral equipment on the path. Particularly, when it is applied to vehicles, it needs no flashlight nor emitting signal of light beam, and it can recognize the body types and speeds of vehicles, and can reduce the chance of inducing shocking a driver or an accident, and the vehicles are unable to detect the recognition system.

With such a technique, the present invention further can separate the recognition of body type and speed into two independent systems for recognizing body types and speeds.

The present invention will be apparent in its feature and effects after reading the detailed description of the preferred embodiment thereof in reference to the accompanying drawings.

### BRIEF DESCRIPTION OF THE DRAWINGS

FIG. 1 is a block diagram showing systematic allocation of the moving thing recognition system of the present invention;

FIG. 2 is a block diagram showing systematic allocation of the moving vehicle recognition system of the present invention applied on a high way;

FIG. 3 is a schematic view showing a camera of the present invention is used on a high way and has a picture taking range set for practicing;

FIG. 4 is a schematic view showing a check aligning device is used to align a picture file with virtual checks;

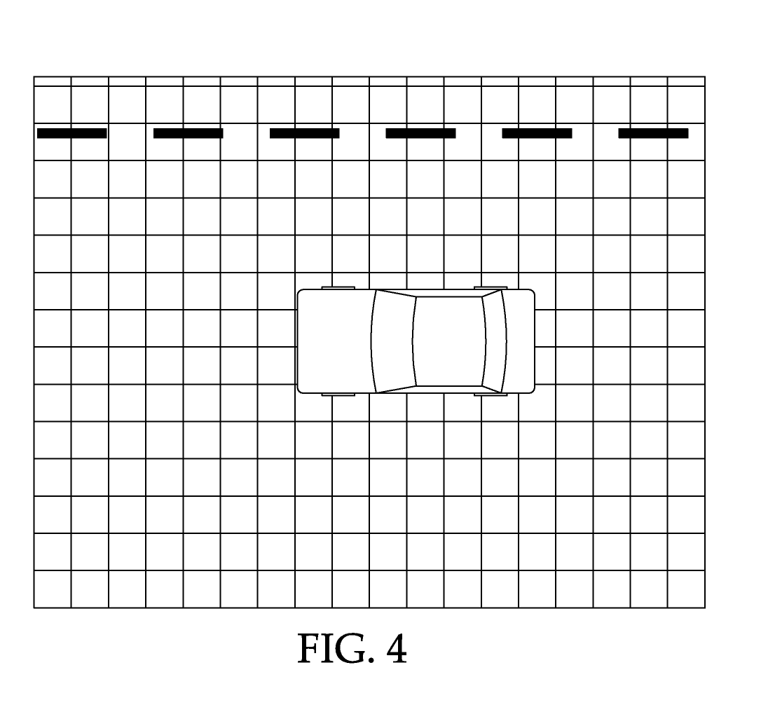

FIG. 5 is a block diagram showing systematic allocation of the recognition system for recognizing the body type of a moving thing of the present invention;

FIG. 6 is a schematic view showing a camera of the present invention is used on a vehicle-type recognition system on a high way and has a picture taking range set for practicing;

FIG. 7 is a block diagram showing systematic allocation of the recognition system for recognizing the speed of a moving thing of the present invention;

FIG. 8 is a schematic view showing a camera of the present invention is used on a vehicle-speed recognition system on a high way and has a picture taking range set for practicing.

### DETAILED DESCRIPTION OF THE PREFERRED EMBODIMENT

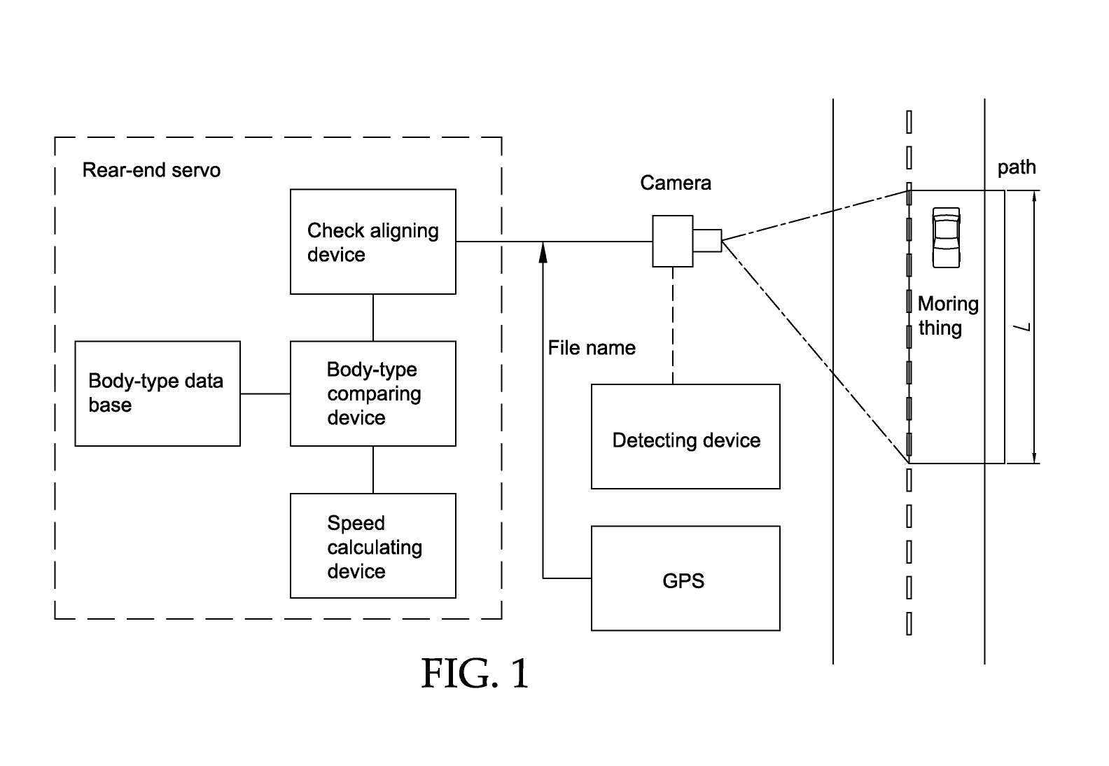

Referring to FIG. 1 which shows a moving thing recognition system of the present invention, the moving thing can be a train, a vehicle or a ship etc.; the present invention mainly is to put at least a camera at an appropriate location on a path that the moving thing is proceeding; the camera is set to have a picture taking range L which at least can take full-length pictures of the moving thing for a length of moving to get multiple serial picture files with high analyzing degree, for example, it can take by the technique of MJPEG.

A detecting device controls the camera for starting taking a picture when it detects that a moving thing enters the picture taking range.

A GPS is used to get the data of longitudinal and latitudinal degrees and data of time of each picture file, thus file names of these picture files can be all established. In which the unit of the data of time can be as small as micro seconds.

A body-type data base establishes various body-type data according to the angular positions of the camera in taking pictures.

A check aligning device is used to align each picture file of the moving thing with virtual checks; these virtual checks are provided in taking the length of a fixed marking article or some other fixed article on the path of the moving thing as a reference.

A body-type comparing device to judge the body type of the moving thing using the way of comparing pictures from a picture file of the full-length pictures taken by the camera with data of the body-type data base.

And a speed calculating device gets differences of distance and time by comparing at least two picture files taken by the camera to calculate the speed of the moving thing.

Wherein the body-type data base, the check aligning device, the body-type comparing device and the speed calculating device are provided in a rear-end servo rear-end servo; while the data of picture file taken by the camera can be sent to the rear-end servo in a way of cable or wireless transmission for recognizing.

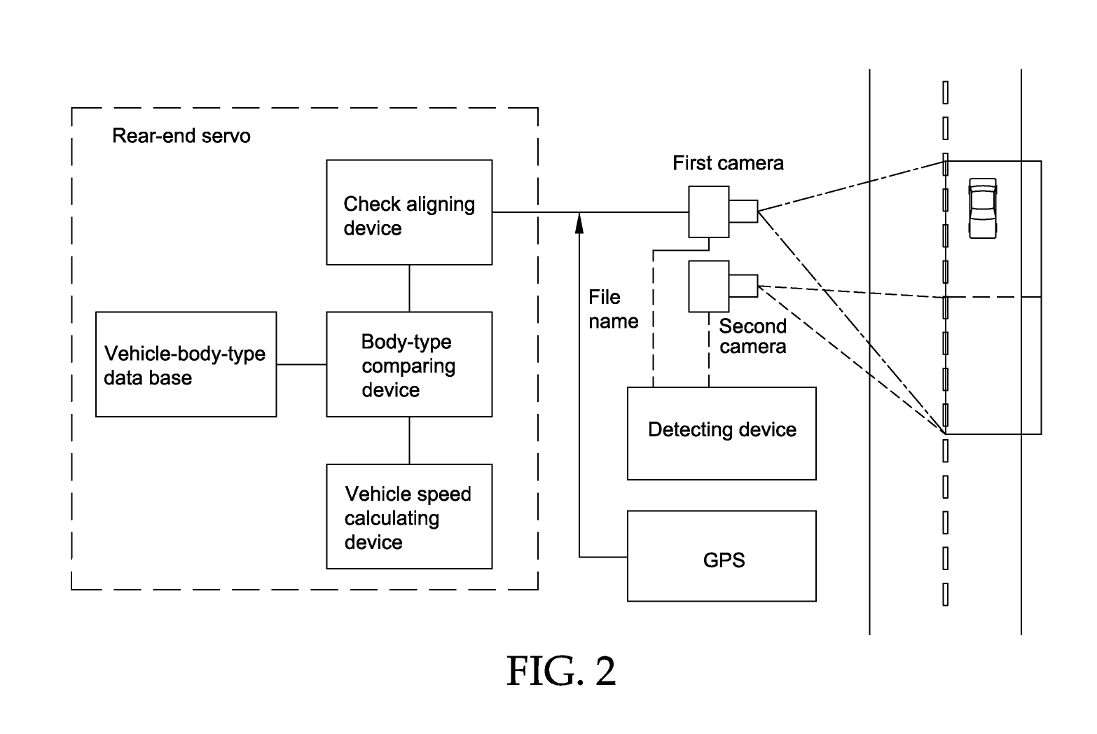

In FIG. 2 which shows an embodiment of a moving vehicle recognition system applied on a high way 4, the system includes a first camera 1, a second camera 2, a detecting device, a GPS, a check aligning device, a vehicle-body-type data base, a body-type comparing device and a speed calculating device.

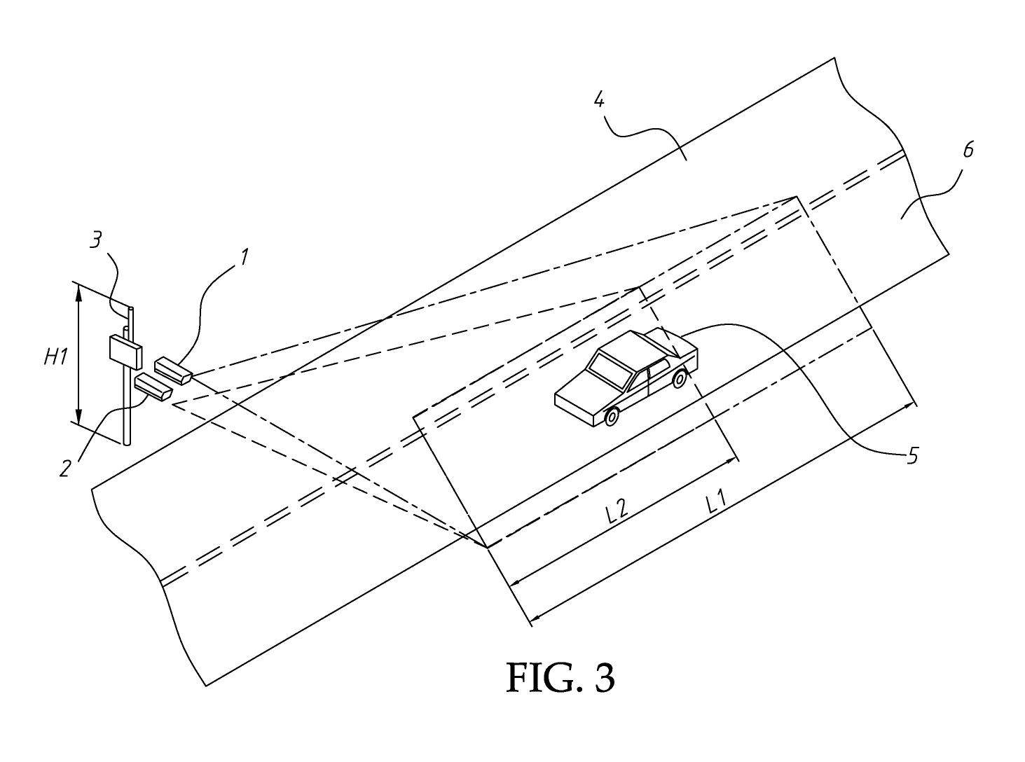

Also please refer to FIG. 3, the first camera 1, the second camera 2 and a rack 3 are set at an appropriate position (at a height of them set as H1, for instance 5 m) on the high way 4, picture of a running vehicle 5 is taken by the technique of MJPEG; the high way 4 has thereon a separating broken line 6.

The first camera 1 is set to have a first picture taking range L1 on the high way 4, the length of the range L1 at least is larger than a length of a longest vehicle plus a distance of driving, e.g. 20 m, in order to obtain a picture file of the vehicle 5 passing the first picture taking range L1.

The second camera 2 is set to have a second picture taking range L2 of 6 m for example; the second picture taking range L2 is set at a position at the rear of the front edge of the first picture taking range L1 where at least the picture of the vehicle 5 is to be taken by the first camera 1, in order to obtain a picture file of the vehicle 5 passing the second picture taking range L2.

The detecting device is used for controlling, when the whole length of the vehicle 5 enters the first picture taking range L1, it activates the first camera 1 to take the picture of the vehicle 5; and when the vehicle 5 enters the second picture taking range L2, it activates the second camera 2 to take the picture of the vehicle 5 too.

The GPS is used to obtain the data of longitudinal and latitudinal degrees and data of time of each picture file, thus a file name of the picture file can be all established. For example, if the position on the GPS is east longitude 52°3′4″, north latitude 38°7′6″, and the time is 13 o'clock 24′16″303 micro seconds on Jul. 1, 2007, then the file name is 52343876070701132416303.

The vehicle-body-type data base establishes various body-type data according to the angular positions of the first camera 1 in taking pictures.

The check aligning device is used to align each picture file of the vehicle taken by the first and the second cameras 1, 2 with virtual checks in the first place; these virtual checks are provided in taking the length of a fixed marking article, or some other additional fixed article able to be taken for reference on the high way (e.g., a predetermined section of the separating broken line 6 on the traffic way as a reference) as a reference, or some other additional article having a known length as a reference of scale.

The body-type comparing device uses the way of comparison of pictures to judge the body type of the vehicle by comparing the picture file data taken by the first camera 1 with the data of the vehicle-body-type data base. While the speed calculating device compares the picture files taken for the second picture taking range L2 with the picture files taken for the first picture taking range L1 to calculate the speed of the vehicle.

Wherein the vehicle-body-type data base, the check aligning device, the body-type comparing device and the speed calculating device are provided in a rear-end servo; while the data of the picture files taken by the first camera 1 and the second camera 2 can be sent to the rear-end servo in a way of cable or wireless transmission for recognizing the vehicle.

Now taking a preferred embodiment for description, in this embodiment, the picture taking range of the first camera 1 is 20 m, the speed of photographing is 30 frames/second, the analyzing degree is Half D1; while for the second camera 2, the picture taking range is 6 m, the speed of photographing is 30 frames/second, the analyzing degree is Half D1; the space between every two virtual transverse check lines (totally 100 lines) for aligning of the picture files taken by the first camera 1 is 20 m, the space between every two virtual transverse check lines (totally 60 lines) for aligning of the picture files taken by the second camera 2 is 10 m. After comparison, the speed can be accurately calculated, and the body-type can be gotten by comparison.

By virtue that the first and the second cameras 1, 2 take 30 pictures each second, as to the feature of the technique of MJPEG, the interspace between two pictures taken when a vehicle passes is 0.033 micro second; when there is no vehicle, the first and the second cameras 1, 2 will send back no picture files.

If the vehicle speed is 300 km/hr., the distance that the vehicle proceeds on in each 0.033 micro second is 2.78 m. The second picture taking range L2 of the second camera 2 is 6 m, this is much larger than 2.78 m. In practicing of such a preferred embodiment therefore, even when the vehicle speed is 300 km/hr., the recognition system of the present invention still can recognize the vehicle speed.

By the fact that the present invention judges the body type or speed of the vehicle running on a high way only with pictures, it needs only to set cameras at a suitable position, this does not change the environment and peripheral equipment on the path; and infrared illumination equipment is used to project infrared light source to the target area at night as a set of auxiliary equipment to complement for the inadequacy of the cameras which thereby become full-time cameras. Particularly, it needs no flashlight, thus can reduce the chance of inducing shocking a driver or an accident.

Further, during recognizing the vehicle speed in running by the present invention, it needs not to emit laser or infrared beam signal; this may render the vehicle unable to detect the recognition system. And by changing of setting, the present invention can recognize extremely high speed of a vehicle, thereby it is extremely practicable.

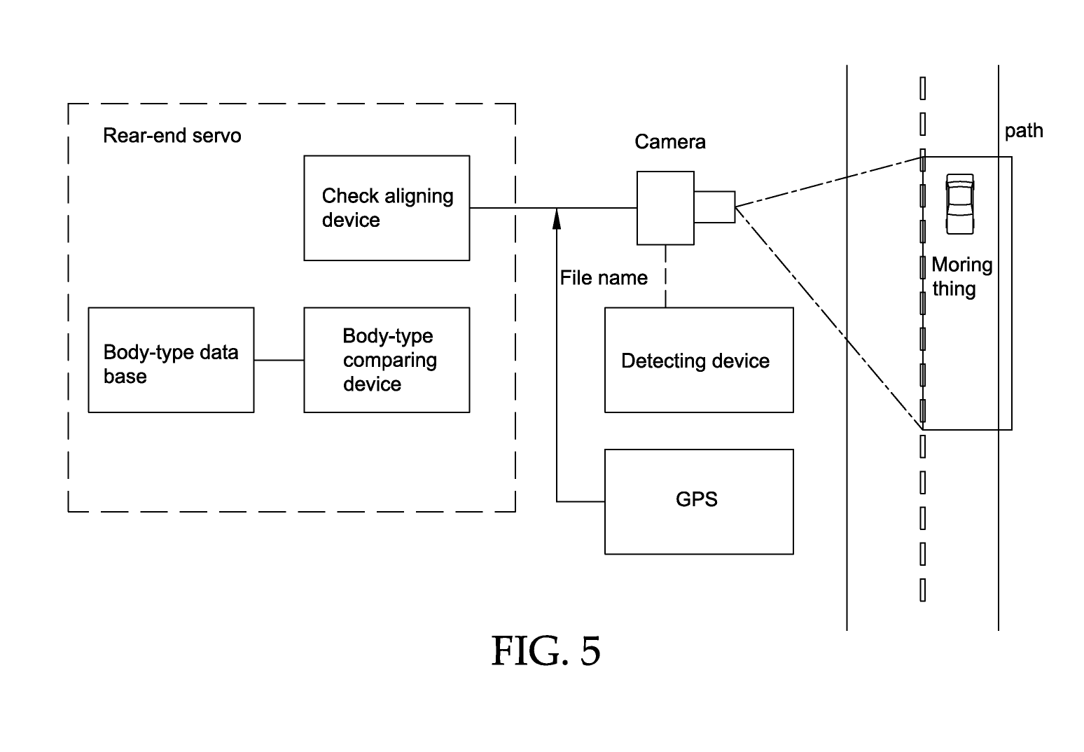

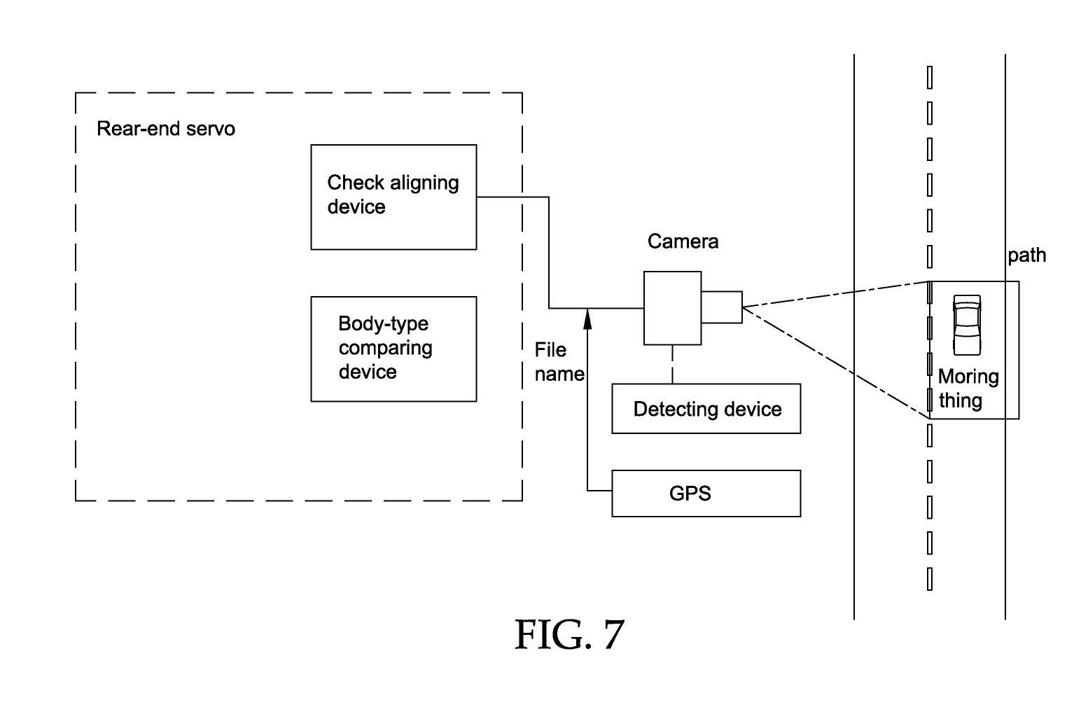

The method stated above of judging the body type and speed of the moving thing only with pictures can also be applied respectively to a recognition system for recognizing the body-type of a moving thing (as shown in FIG. 5) and a recognition system for recognizing the speed of a moving thing (as shown in FIG. 7).

Referring to FIG. 5 which shows the recognition system for recognizing the body-type of a moving thing, the recognition system has a camera to take picture files in the MJPEG picture form, and is put at an appropriate position on the path of the moving thing, and is set to have a picture taking range which at least can take a full-length picture of the moving thing on the path to get picture files of the moving thing passing the first picture taking range. The recognition system further has a detecting device, a GPS, a check aligning device, a body-type data base and a body-type comparing device all being same as those stated above for FIG. 1; thereby an independent body-type recognizing system for recognizing body types moving things is established.

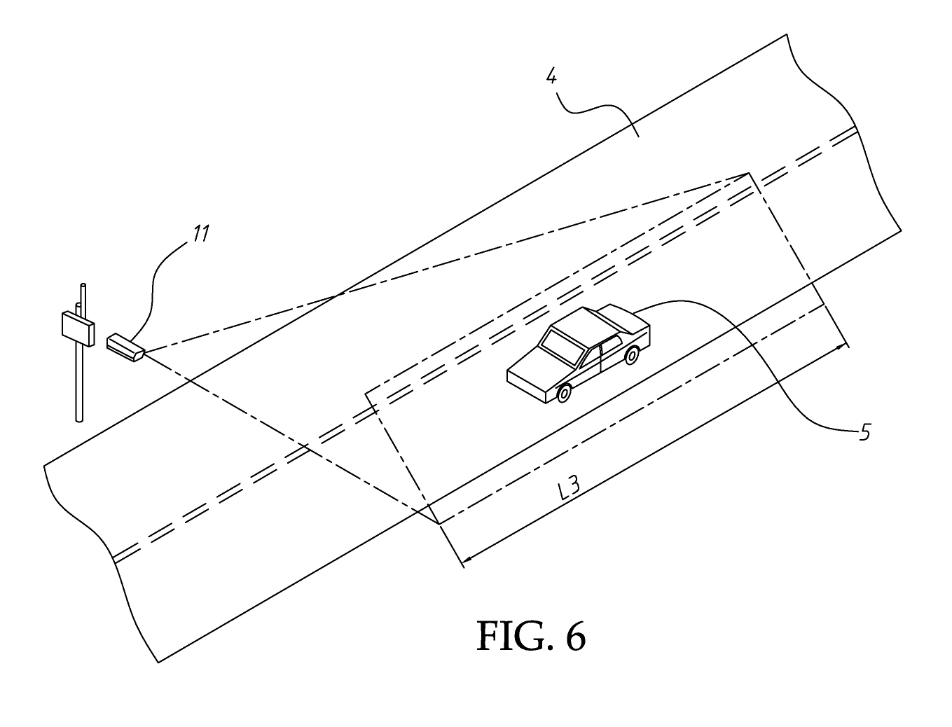

FIG. 6 is a schematic view showing practical allocation the system of the present invention on a high way 4 to recognize vehicle types, of which a camera 11 is set at an appropriate position on the high way 4, the camera 11 is set to have a picture taking range L3 to take pictures of vehicles passing; further file names, check aligning and comparing functions etc. all can be established in these picture files to recognize vehicle types.

FIG. 7 shows a moving-thing speed recognition system, it has a camera to take picture files in the MJPEG picture form, and is put at an appropriate position on the path of the moving thing, and is set to have a picture taking range which at least can take two picture files of the moving thing taken when the moving thing passes by. The recognition system further has a detecting device, a GPS, a check aligning device and a speed calculating device all being same as those stated above for FIG. 1; thereby an independent moving-thing speed recognizing system for recognizing body types moving things is established.

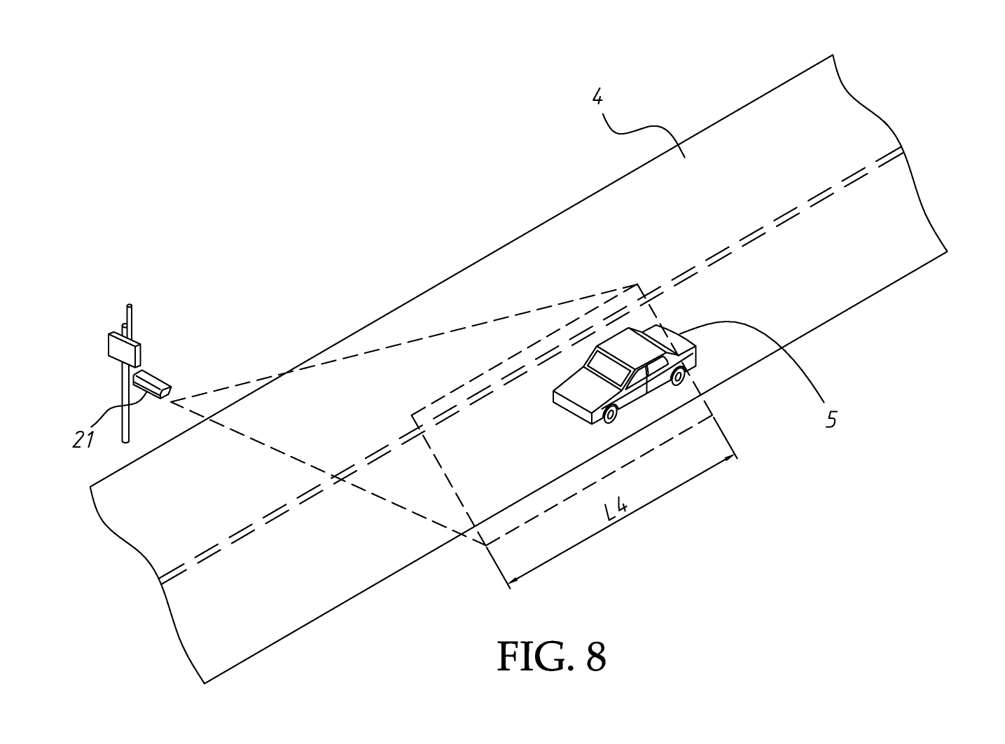

FIG. 8 is a schematic view showing practical allocation the moving-thing speed recognition system on a high way 4 to recognize vehicle speed, of which a camera 21 is set at an appropriate position on the high way 4, the camera 21 is set to have a picture taking range L4 to take pictures of vehicles passing; further file names, check aligning and vehicle speed calculating functions etc. all can be established in these picture files to recognize vehicle speeds.

Obviously, the present invention is not limited to the above embodiments; it will be apparent to those skilled in this art that various modifications or equivalent changes without departing from the spirit of this invention, for instance, other embodiment to judge information of a running vehicle only with pictures according to the thought equivalent to that of the present invention, such as using cameras to take pictures with high analyzing degrees or other cameras in the amount of one or more than two, shall also fall within the scope of the appended claims.

1. A moving thing recognition system comprising:
at least a camera being set to have a picture taking range, said picture taking range at least being adapted to taking full-length pictures of said moving thing for a length of moving to get multiple serial picture files with high analyzing degree;
a detecting device to control said camera for starting taking a picture when it detecting that said moving thing enters said picture taking range;
a GPS used to get data of longitudinal and latitudinal degrees and data of time of each of said picture files, thus file names of said picture files being established;
a body-type data base establishing various body-type data according to angular positions of said camera in taking pictures of said moving thing;
a check aligning device used to align each of said picture files of said moving thing with virtual checks; said virtual checks being provided in taking length of a fixed marking article or some other fixed article on a path of said moving thing as a reference;
a body-type comparing device to judge said body type of said moving thing using a way of comparing pictures from one of said picture files of said full-length pictures taken by said camera with data of said body-type data base; and
a speed calculating device to get differences of distance and time by comparing at least two of said picture files taken by said camera to calculate speed of said moving thing.

2. The moving thing recognition system as claimed in claim 1, wherein said body-type data base, said check aligning device, said body-type comparing device and said speed calculating device are provided in a rear-end servo; while said data of picture file taken by said camera are sent to said rear-end servo in a way of cable or wireless transmission for recognizing.

3. The moving thing recognition system as claimed in claim 1, wherein said camera takes pictures in a MJPEG form.

4. The moving thing recognition system as claimed in claim 1, wherein unit of said data of time is as small as micro seconds.

5. The moving thing recognition system as claimed in claim 1, wherein said moving thing is a train.

6. The moving thing recognition system as claimed in claim 1, wherein said moving thing is a vehicle.

7. The moving thing recognition system as claimed in claim 1, wherein said moving thing is a ship.

8. A moving thing recognition system comprising:
a camera set at an appropriate position on a path of said moving thing, and being set to have a picture taking range to take a picture at least of full-length of said moving thing on said path to get picture files of said moving thing passing said picture taking range;
a detecting device to control said camera for starting taking a picture when it detecting that said moving thing enters said picture taking range;
a GPS used to get data of longitudinal and latitudinal degrees and data of time of each of said picture files, thus file names of said picture files being established;
a body-type data base establishing various body-type data according to angular positions of said camera in taking pictures of said moving thing;
a check aligning device used to align said picture files of said moving thing taken by said camera with virtual checks; said virtual checks being provided in taking length of a fixed marking article or some other fixed article on said path of said moving thing as a reference;
a body-type comparing device to judge said body type of said moving thing using a way of comparing pictures from said picture file taken by said camera.

9. The moving thing recognition system as claimed in claim 8, wherein said body-type data base, said check aligning device, said body-type comparing device and said body-type comparing device are provided in a rear-end servo; while said data of picture file taken by said camera are sent to said rear-end servo in a way of cable or wireless transmission for recognizing.

10. The moving thing recognition system as claimed in claim 8, wherein said camera takes pictures in a MJPEG form.

11. The moving thing recognition system as claimed in claim 8, wherein unit of said data of time is as small as micro seconds.

12. The moving thing recognition system as claimed in claim 8, wherein said moving thing is a train.

13. The moving thing recognition system as claimed in claim 8, wherein said moving thing is a vehicle.

14. The moving thing recognition system as claimed in claim 8, wherein said moving thing is a ship.

15. A moving thing recognition system comprising:
a camera set at an appropriate position on a path of said moving thing, and being set to have a picture taking range which at least is adapted to taking two picture files of said moving thing taken when said moving thing passes by said picture taking range;
a detecting device to activate said camera for taking a picture of said moving thing when said moving thing enters said picture taking range;
a GPS used to get data of longitudinal and latitudinal degrees and data of time of each of said picture files, thus file names of said picture files being established;
a check aligning device used to align each of said picture files of said moving thing with virtual checks; said virtual checks being provided in taking length of a fixed marking article or some other fixed article on a path of said moving thing as a reference; and
a speed calculating device to get differences of distance and time by comparing at least two of said picture files taken by said camera to calculate speed of said moving thing.

16. The moving thing recognition system as claimed in claim 15, wherein said check aligning device and said speed calculating device are provided in a rear-end servo; while said data of picture file taken by said camera are sent to said rear-end servo in a way of cable or wireless transmission for recognizing.

17. The moving thing recognition system as claimed in claim 15, wherein said camera takes pictures in a MJPEG form.

18. The moving thing recognition system as claimed in claim 15, wherein unit of said data of time is as small as micro seconds.

19. The moving thing recognition system as claimed in claim 15, wherein said moving thing is a train.

20. The moving thing recognition system as claimed in claim 15, wherein said moving thing is a vehicle.

21. The moving thing recognition system as claimed in claim 15, wherein said moving thing is a ship.

22. A moving thing recognition system comprising:
a first camera set at a predetermined position on a high way, being set to have a first picture taking range with a length at least larger than a length of a longest vehicle plus a distance of driving, in order to obtain a picture file of said vehicle passing said first picture taking range;
a second camera set at a predetermined position on said high way, being set to have a second picture taking range; said second picture taking range being set at a position at rear of a front edge of said first picture taking range where at least a picture of said vehicle is to be taken by said first camera, in order to obtain a picture file of said vehicle passing said second picture taking range;
a detecting device to activate said camera for starting taking a picture when whole length of said vehicle enters said first picture taking range, and to activate said second camera to take a picture of said vehicle when said vehicle enters said second picture taking range;
a GPS used to get data of longitudinal and latitudinal degrees and data of time of each of said picture files, thus file names of said picture files being established;
a vehicle-body-type data base establishing various vehicle-body-type data according to angular positions of said first camera in taking pictures;
a check aligning device used to align each of said picture files of said vehicle taken by said first and said second cameras with virtual checks firstly; said virtual checks are provided in taking a length of a fixed marking article or some other additional fixed article on said high way as a reference;
a body-type comparing device to judge said body type of said vehicle using a way of comparing pictures from said picture file of said vehicle taken by said first camera; and
a speed calculating device to compare said picture files taken for said second picture taking range with said picture files taken for said first picture taking range to calculate speed of said vehicle.

23. The moving thing recognition system as claimed in claim 22, wherein said fixed marking article on said high way selected for said check aligning device is a separating broken line on said high way.

24. The moving thing recognition system as claimed in claim 22, wherein said vehicle-body-type data base, said check aligning device, said body-type comparing device and said speed calculating device are provided in a rear-end servo; while said data of picture file taken by said first and said second cameras are sent to said rear-end servo in a way of cable or wireless transmission for recognizing.

25. The moving thing recognition system as claimed in claim 22, wherein said picture taking range of said first camera is 20 m, speed of photographing is 30 frames/second, analyzing degree is Half D1; while for said second camera, said picture taking range is 6 m, speed of photographing is 30 frames/second, analyzing degree is Half D1.

26. The moving thing recognition system as claimed in claim 24, wherein space between every two of said virtual transverse check lines (totally 100 lines) for aligning of said picture files taken by said first camera is 20 m, while space between every two of said virtual transverse check lines (totally 60 lines) for aligning of said picture files taken by said second camera is 10 m.

27. The moving thing recognition system as claimed in claim 24, wherein said first and said second cameras take pictures in a MJPEG form.
